(19) United States
(12) Patent Application Publication
(10) Pub. No.: US 2018/0143436 A1
(43) Pub. Date: May 24, 2018

(54) HEAD-OPERATED DIGITAL EYEGLASSES

(71) Applicant: Peishu XIE, Nanjing (CN)

(72) Inventor: Peishu XIE, Nanjing (CN)

(21) Appl. No.: 15/566,634

(22) PCT Filed: Jul. 16, 2016
(86) PCT No.: PCT/CN2016/090236

§ 371 Date: Oct. 13, 2017

(30) Foreign Application Priority Data
Jul. 20, 2015 (CN) 201510428409.8
Jul. 22, 2015 (CN) 201510436115.X
Mar. 17, 2016 (CN) 201610152700.1
May 22, 2016 (CN) 201610344062.3
Jun. 23, 2016 (CN) 201610458398.2
Jul. 11, 2016 (CN) 201610544134.9

(51) Int. Cl. G02B 27/01; G06F 3/038; G06F 3/01; G06F 3/0346; G06F 1/16

(52) U.S. Cl. CPC G02B 27/0172; G06F 3/038; G06F 3/012; G06F 3/013; G02B 2027/0134; G06F 3/017; G06F 1/163; G02B 2027/0178; G02B 2027/014; G06F 3/0346

(57) ABSTRACT

A pair of digital eyeglasses, including the following components: a left temple, a right temple, a left display device, a right display device, a left infrared transmitter, a right infrared transmitter, a left infrared receiver, a right infrared receiver, a head angular velocity detector, a torso angular velocity receiving interface, a processor, a memory, and a power supply. It allows the user to rapidly and accurately operate the pointer with the head and to output the image information into broad, three-dimensional space.

### TECHNICAL FIELD

The present invention involves one display device, specifically a head-mounted display device.

### BACKGROUND ART

Digital eyeglasses are the head-mounted display device capable of displaying the digital signals, including augmented reality glasses, virtual reality glasses, smart glasses, etc.

Mobile phone and tablet PC are the mainstream mobile communication devices. Mobile phone has the narrow display zone, while a tablet PC is heavy. Additionally, a mobile phone and tablet PC can only display two-dimensional images, requiring the user to change his/her head gestures, thus limiting their respective ranges of application.

Digital eyeglasses can output the images to broad, three-dimensional space through near-eye display (NED). But the current digital eyeglasses are difficult to input the characters. The speech recognition input method has the recognition error and poor interference immunity. Though the touchpad can finish the character input, it will occupy the resources of at least one hand. When both hands of the user are in the busy status, it is difficult to input the characters with the touchpad. Though the eyeball tracking device can operate the digital eyeglasses through the eyeball movement, the pointer of the eyeball tracking device has low movement accuracy and is susceptible to the interference of environmental light.

In this article, one kind of digital eyeglasses has been designed, allowing the user to rapidly and accurately operate the pointer through the head, and output the image information into broad, three-dimensional space. Now there is no literature to publicize the method of manufacturing such a product.

### CONTENTS OF THE INVENTION

The present invention aims to provide one kind of head-operated digital eyeglasses and the operation method, allowing the user to rapidly and accurately operate the pointer by means of the head and then output the image information into broad, three-dimensional space.

Digital eyeglasses include the left temple, right temple, left display device, right display device, left infrared transmitter, right infrared transmitter, left infrared receiver, right infrared receiver, head angular velocity detector, torso angular velocity receiving interface, processor, memory and power supply.

The display device is a video output device, including projector, LCD panel, etc.

In this paragraph, it is supposed that the user always wears the digital eyeglasses. The left display device is situated in front of the user's left eye, and the right display device is situated in front of the user's right eye.

Infrared transmitter can continuously emit the infrared, and can also emit the infrared in the fixed time interval. When the user opens the eyes, the infrared emitted by the infrared transmitter irradiates the eyes to reflect strong infrared light. When the user closes the eyes, the light ray emitted by the display device irradiates the eyes to reflect weak infrared light. Infrared receiver can convert the reflected infrared light into digital signal. Left infrared transmitter emits infrared light onto the user's left eye, and the left infrared receiver receives the infrared light reflected by the user's left eye. The right infrared transmitter emits the infrared light onto the user's right eye, and the right infrared receiver receives the infrared light reflected by the user's right eye. The infrared receiver converts the received infrared intensity into one digital signal or one group of digital signals, and sends it to the processor. If the infrared receiver is single pixel infrared camera, it outputs one digital signal; if infrared receiver is multi-pixel infrared camera, it outputs one group of digital signals. Within the range of response, with the increase of the inputted infrared intensity, the digital signals outputted by the infrared receiver increase; otherwise, the digital signals outputted by the infrared receiver decrease.

Assume that 0<p₁<q₁ and 0<p₂<q₂. Assume that the sum of the signals outputted by the left infrared receiver is l, and the sum of the signals outputted by the right infrared receiver is r. If lϵ[q₁,+∞), the processor judges that the user's left eye is open; if lϵ[p₁,q₁), the processor judges that the user's left eye squints; if lϵ[0,p₁), the processor judges that the user's left eye is closed. If rϵ[q₂,+∞), the processor judges that the user's right eye is open; if rϵ[p₂,q₂), the processor judges that the user's right eye squints; if rϵ[0,p₂), the processor judges that the user's right eye is closed.

Assume that sϵ(0,3000). Some proper names are defined below.

Single squint-blink of the left eye: the user's right eye is open all the time, and the user's left eye cannot be closed. At the same time, the user's left eye is first open, then squints for s milliseconds, and finally opens.

Single squint-blink of the right eye: the user's left eye is open all the time, and the user's right eye cannot be closed. At the same time, the user's right eye is first open, then squints for s milliseconds, and finally opens.

Single squint-blink: single squint-blink of the left eye or single squint-blink of the right eye.

Double squint-blink: the user's eyes cannot be closed. Moreover, the user's eyes open at the same time, then squint for s milliseconds at the same time, and finally open at the same time.

Squint-blink: single squint-blink or double squint-blink.

Single blink of the left eye: the user's right eye is open all the time. Moreover, the user's left eye is first open, then is closed for s milliseconds, and finally opens.

Single blink of the right eye: the user's left eye is open all the time. Moreover, the user's right eye is first open, then is closed for s milliseconds, and finally opens.

Single blink: single blink of the left eye or single blink of the right eye.

Double blink: the user's eyes open at the same time, then are closed for s milliseconds at the same time, and finally open at the same time.

Thus, left infrared receiver, right infrared receiver and processor can identify the user squint-blink instruction and single blink instruction. For squint-blink and single blink, it is possible to eliminate the unconscious double blink of human eyes, and reduce the risk of incorrect operation. Squint-blink is more relaxing and quicker than blink. Squint-blink will not close the user's field of vision.

Double squint-blink instruction, left eye's single squint-blink instruction, right eye's single squint-blink instruction, left eye's single blink instruction and right eye's single blink instruction can trigger different events.

Angular velocity detector is the instrument testing the carrier angular velocity. Common angular velocity detector is triaxial angular velocity gyroscope, whose support center serves as the origin of the gyroscope coordinate system, and whose principal axis, horizontal axis and vertical axis constitute the coordinate axes of gyroscope coordinate system. Therefore, triaxial angular velocity gyroscope can detect the three-dimensional angular velocity vector.

The head angular velocity detector is worn on the head, capable of detecting three-dimensional angular velocity vector [a₁,a₂,a₃] of the head. The head angular velocity detector can detect the torso angular movement noise. So, digital eyeglasses can be increased with one torso angular velocity detector to eliminate the angular velocity noise generated by the torso angular movement. The torso angular velocity detector is worn on the torso, capable of detecting three-dimensional angular velocity vector [b₁,b₂,b₃] of the torso. The torso angular velocity receiving interface can receive the torso angular velocity vector through the wired connection with torso angular velocity transmitter, and the torso angular velocity receiving interface can also receive the torso angular velocity vector indirectly through the wired connection with torso angular velocity receiver. The torso angular velocity receiver can receive the torso angular velocity vector through the wired communication or wireless communication.

Digital eyeglasses can also include the following components: left temple, right temple, left display device, right display device, left infrared transmitter, right infrared transmitter, left infrared receiver, right infrared receiver, head angular velocity detector, torso angular velocity detector, processor, memory and power supply. At this moment, torso angular velocity detector sends torso angular velocity vector to the processor through the wired communication or wireless communication.

Digital eyeglasses can also include the following components: left temple, right temple, left display device, right display device, left infrared transmitter, right infrared transmitter, left infrared receiver, right infrared receiver, head angular velocity detector, torso angular velocity detector, perspiration-resistant tape, processor, memory and power supply. At this moment, one side of perspiration-resistant tape can be fixed with the torso gyroscope, and the other side can be pasted on the epidermis of the torso. The perspiration-resistant tape can prevent the falloff of torso gyroscope due to sweating of the user. It can fix the torso gyroscope on the user torso for a long time. The pasting and tear-off of the perspiration-resistant tape is very convenient, and the user is allowed to operate the digital eyeglasses in the bumping situation.

“Head relative angular velocity vector” is as defined below.

Head relative angular velocity vector: the angular velocity vector whereby the head makes the three-dimensional rotation relative to the torso.

The processor can detect the status of the torso angular velocity detector, and output it to the user through the audio signal or video signal. The torso angular velocity detector has four statuses: angular velocity detector successfully connected, angular velocity detector connection failure, angular velocity detector successfully matched, and angular velocity detector matching failure.

If the torso angular velocity receiving interface receives the torso angular velocity vector, the processor will notify the user: angular velocity detector is successfully connected; otherwise, the processor will notify the user: angular velocity detector connection fails.

The head angular velocity detector can output the direction of the head angular velocity coordinate axis to the processor. The torso angular velocity detector can output the direction of the torso angular velocity coordinate axis to the processor. The processor can calculate coordinate axis direction difference X of the head angular velocity detector and torso angular velocity detector, and judge whether the angular velocity detector matching is successful. If X=0, the coordinate axis direction of the head angular velocity detector is consistent with that of the torso angular velocity detector, and the processor will notify the user that angular velocity detector matching has succeeded; if X≠0, the coordinate axis direction of the head angular velocity detector is inconsistent with that of the torso angular velocity detector, whereby the processor will notify the user that angular velocity detector matching has failed.

Assuming c₁=a₁−b₁, c₁=a₁−b₁, c₁=a₁−b₁, the head relative angular velocity vector is [c₁,c₂,c₃].

If angular velocity detector connection fails or matching fails, the processor will set torso angular velocity vector [b₁,b₂,b₃] as zero vector [0,0,0]. At this moment, head relative angular velocity vector is [a₁,a₂,a₃].

If digital eyeglasses have the torso angular velocity detector, and the coordinate axis direction of the torso angular velocity detector is consistent with that of the head angular velocity detector, the processor is not required to detect the status of the torso angular velocity detector.

The processor translates the origin of the coordinate system of the head angular velocity detector to the cervical apex of the user, by using the coordinate axis direction of the head angular velocity detector as that of the head coordinate system. Then, the processor will build a three-dimensional head coordinate system for the head of the user. In whatever movement status for the user's head, the origin of the head coordinate system is always in the cervical apex of the user, and the coordinate axis direction of the head coordinate system is always consistent with the coordinate axis direction of the head angular velocity detector.

The dead-ahead direction of the digital eyeglasses is consistent with the dead-ahead direction of the user's eyes. Assume that the head status is the initial status when the user stands up, the angle of rotation up and down for the user's head α meets

$$α ∈ [ - \frac{4 π}{5} , \frac{4 π}{5} ] ,$$

and the angle of left and right rotation of the user head β meets

$$β ∈ [ - \frac{4 π }{5} , \frac{4 π}{5} ] .$$

The operation interface is a virtual plane object in the three-dimensional space, it is stored in the form of electronic data in the memory. It is situated in front of the user's glasses. The front here includes dead-ahead front, upper front, lower front, left front and right front. The operation interface is always stable in relation to the head.

The pointer is situated on the two-dimensional operation interface, and its tip coordinate can be expressed with two-dimensional vector. The pointer may have two statuses for switching: “movement disabled” and “movement enabled.” When the pointer is in “movement disabled” status, the pointer cannot move; when the pointer is in “movement enabled” status, the pointer can move. “Movement disabled” can eliminate the interference by the non-operative head shake of the user.

The pointer can have two statuses available for switching: “pointer disabled” and “pointer enabled.” When the pointer is in the “pointer disabled” status, the pointer cannot move or click; when the pointer is in the “enabled” status, the pointer can move and click. The “pointer disabled” status can eliminate the interference by the non-operative head shake of the user.

Assume that tϵ[800,+∞). The user may switch the pointer status by using the head. There are two methods for the head to switch pointer status:

1. The user makes squint-blink or single blink;

2. The user continues the squint for more than t milliseconds or keeps a single eye closed for more than t milliseconds;

After switching the status, the pointer can immediately send out a specific video prompt signal to prompt the status change.

The user can move the pointer with the head. The angular velocity component for the left and right rotation of the head is d₁, and the angular velocity component for the up-and-down rotation of the head is d₂. It is known that head relative angular velocity vector is [c₁,c₂,c₃]. From three-dimensional angular velocity vector [c₁,c₂,c₃], it is possible to extract the two-dimensional angular velocity vector [d₁,d₂]. d₁ can generate the horizontal displacement component of the pointer, and d₂ can generate the vertical displacement component of the pointer.

Assume that k₁ϵ(0,+∞), k₂ϵ(0,+∞). The method whereby the head moves the pointer includes the following steps:

S1. If the pointer is in the “movement disabled” or “pointer disabled” status, then it switches to S1; otherwise, switches to S2;

S2. The processor calculates the two-dimensional vector [d₁,d₂] and then switches to S3;

S3. The processor multiplies the components of two-dimensional vector [d₁,d₂] by the scaling factor k₁ and k₂, thus generating the pointer displacement vector [k₁·d₁,k₂·d₂], and switches to S4;

S4. The processor adds the pointer displacement vector [k₁·d₁,k₂·d₂] onto the current pointer coordinates, moves the pointer on the operation interface and switches to S1.

The user may use the head to click the pointer. The method for the head to click the pointer is: the user makes squint-blink or single blink.

After clicking the pointer, the processor can immediately send out a specific video prompt signal to prompt the completion of clicking. For example, after clicking of the pointer, the pointer will flash once to prompt the completion of clicking. The processor can send out various types of video prompt signals to prompt the completion of the instructions. For example, after the completion of the instruction for single blink of the left eye, the processor will flash with a red circle on the pointer to prompt the completion of the instruction; after the completion of the instruction for single blink of the right eye, the processor will flash with one blue circle on the pointer to prompt the completion of the instruction.

Therefore, the user is only required to turn the head and make the squint-blink in order to click any button on the operation interface. Similarly, the user is only required to turn the head and make the squint-blink in order to input the text with the soft keyboard.

The display device may be transparent display device. Transparent display device can display the operation interface in the lower part of the display device, thus avoiding the blocking of the sight line of user by the operation interface, and therefore allowing the user to walk normally. The external surface of transparent display device can be covered with an electro-chromic substance. Electro-chromic substances allow for the adjustment of light transmittance, thus capable of shielding the ambient light, and increasing the contrast of the virtual picture. The head-operated digital eyeglasses not only free both hands of the user, but also free both feet of the user.

The digital eyeglasses can include precious decorative materials, such as precious metals and jewels. The decorative materials can decorate the head of the user.

The digital eyeglasses can be installed with the camera, to send the collected real images to the processor. Then the processor can integrate and output the real images and virtual images to the display device. The camera can take photos and record the videos. The camera may be infrared camera, to collect the infrared images.

The digital eyeglasses can be installed with the microphone and loudspeaker, to receive and transmit the audio information. The digital eyeglasses can be installed with the communication chips to realize the remote communication.

The digital eyeglasses can be installed with the eyeball tracking device, to realize the eyeball control function.

The digital eyeglasses can also be equipped with various types of software. For example, the digital eyeglasses can be installed with the voice recognition software, to output the recognized text into the display device.

The power supply may be the built-in power supply, or external power supply.

In summary, the head-operated digital eyeglasses can fully free both hands and both feet of the user. Such eyeglasses allow the user to rapidly and accurately operate the pointer with the head, and can output the image information to broad, three-dimensional space.

### DESCRIPTION OF FIGURES

FIG. 1 is the front view of the display module.

FIG. 2 is the front view of the gyro tape.

### METHOD OF CARRYING OUT THE INVENTION

One preferred embodiment for the present invention is provided below, in combination with the attached figures for the description of the present invention.

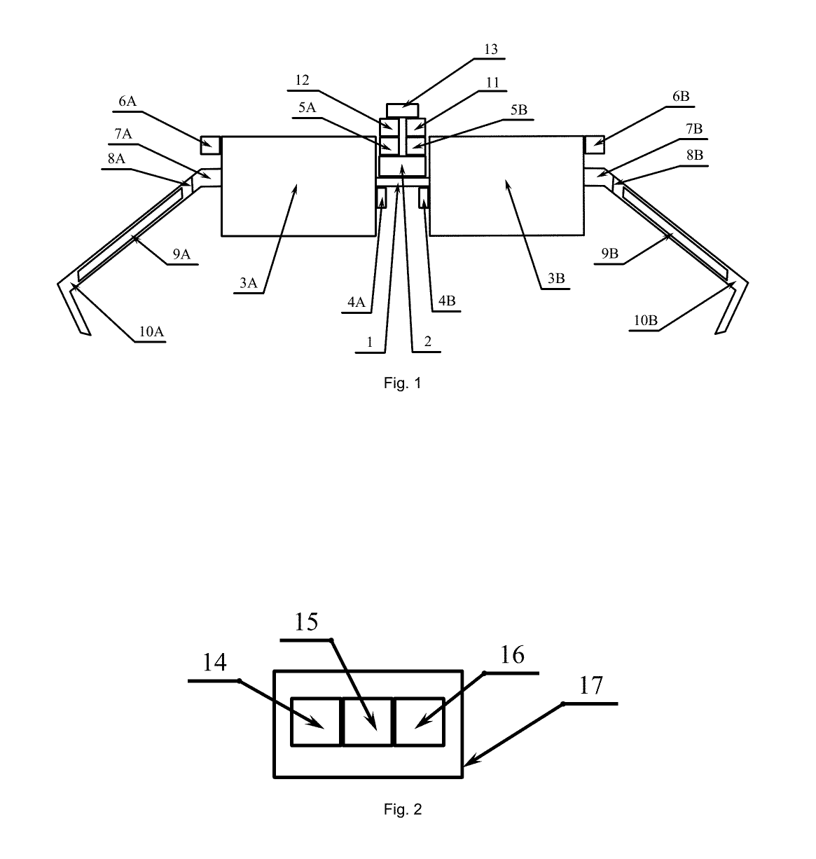

Digital eyeglasses embodiment includes two modules: display module and gyro tape. As shown in FIG. 1, the display module includes the following components: nose bridge (1), processor (2), display device (3A), display device (3B), nose pad (4A), nose pad (4B), infrared transmitter (5A), infrared transmitter (5B), infrared receiver (6A), infrared receiver (6B), pile tip (7A), pile tip (7B), hinge (8A), hinge (8B), power supply (9A), power supply (9B), temple (10A), temple (10B), head angular velocity gyroscope (11), torso angular velocity receiver (12), memory (13). As shown in FIG. 2, the gyro tape includes the following components: torso angular velocity gyroscope (14), torso angular velocity transmitter (15), power supply (16), and perspiration-resistant breathable tape (17).

In this paragraph, it is supposed that the user always wears the digital eyeglasses. The display device (3A) is situated in front of the user's left eye, and the display device (3B) is situated in front of the user's right eye.

Infrared transmitter can continuously emit the infrared, and can also emit the infrared in the fixed time interval. When the user opens the eyes, the infrared emitted by the infrared transmitter irradiates the eyes to reflect strong infrared light. When the user closes the eyes, the light ray emitted by the display device irradiates the eyes to reflect weak infrared light. Infrared receiver can convert the reflected infrared light into digital signal. The infrared transmitter (5A) emits infrared light onto the user's left eye, and the infrared receiver (6A) receives the infrared light reflected by the user's left eye. The infrared transmitter (5B) emits the infrared light onto the user's right eye, and the infrared receiver (6B) receives the infrared light reflected by the user's right eye. The infrared receiver (6A) and infrared receiver (6B) convert the received infrared intensity into one digital signal, and send it to the processor (2). Within the range of response, with the increase of the inputted infrared intensity, the digital signals outputted by the infrared receiver increase; otherwise, the digital signals outputted by the infrared receiver decrease.

Assume that 0<p₁<q₁ and 0<p₂<q₂. Assume that the sum of output signals of the infrared receiver (6A) is l and the sum of the output signal of the infrared receiver (6B) is r. If lϵ[q₁,+∞), the processor (2) judges that the user's left eye is open; if lϵ[p₁,q₁), the processor (2) judges that the user's left eye squints; if lϵ[0,p₁), the processor (2) judges that the user's left eye is closed. If rϵ[q₂,+∞), the processor (2) judges that the user's right eye is open; if rϵ[p₂,q₂), the processor (2) judges that the user's right eye squints; if rϵ[0,p₂), the processor (2) judges that the user's right eye is closed.

Assume that sϵ(0,3000). Some proper names are defined below.

Single squint-blink of the left eye: the user's right eye is open all the time, and the user's left eye cannot be closed. At the same time, the user's left eye is first open and then squints for s milliseconds and finally opens.

Single squint-blink of the right eye: the user's left eye is open all the time, and the user's right eye cannot be closed. At the same time, the user's right eye is first open and then squints for s milliseconds, and finally opens.

Single squint-blink: single squint-blink of the left eye or single squint-blink of the right eye.

Double squint-blink: the user's eyes cannot be closed. Moreover, the user's eyes open at the same time, then squint for s milliseconds at the same time, and finally open at the same time.

Squint-blink: single squint-blink or double squint-blink.

Single blink of the left eye: the user's right eye is open all the time. Moreover, the user's left eye is first open, then is closed for s milliseconds, and finally opens.

Single blink of the right eye: the user's left eye is open all the time. Moreover, the user's right eye is first open, then is closed for s milliseconds, and finally opens.

Single blink: single blink of the left eye or single blink of the right eye.

Double blink: the user's eyes open at the same time, then are closed for s milliseconds at the same time, and finally open at the same time.

Thus, infrared receiver (6A), infrared receiver (6B) and processor (2) can identify the user squint-blink instruction and single blink instruction. For squint-blink and a single blink, it is possible to eliminate the unconscious double blink of the human eyes and thereby reduce the risk of incorrect operation. Squint-blink is more relaxing and quicker than a blink. Squint-blink will not reduce the user's field of vision.

The head angular velocity gyroscope (11) and torso angular velocity gyroscope (14) are angular velocity detectors. The coordinate axis direction of the head angular velocity gyroscope (11) is consistent with that of the torso angular velocity gyroscope (14). The head angular velocity gyroscope (11) is a triaxial angular velocity gyroscope. Its support center serves as the origin of gyroscope coordinate system, and its main axis, horizontal axis and vertical axis constitute the coordinate axes of the gyroscope coordinate system. So, the head angular velocity gyroscope (11) can detect three-dimensional angular velocity vector. It is fixed on the digital eyeglasses in order to detect the three-dimensional angular velocity vector [a₁,a₂,a₃] of the head. The torso angular velocity receiver (12) can receive the torso angular velocity coordinate axis direction and torso angular velocity vector by means of wired or wireless communication.

The torso angular velocity gyroscope (14) can be fixed on the perspiration-resistant breathable tape (17). Perspiration-resistant breathable tape (17) has the functions of perspiration-resistance and breathability. Perspiration-resistant breathable tape (17) can be attached to the epidermis of the torso, to fix the torso angular velocity gyroscope (14). Gyro tape allows the user to operate the digital eyeglasses in situations that are prone to bumping. The torso angular velocity gyroscope (14) can detect the three-dimensional angular velocity vector [b₁,b₂,b₃] of the torso. The torso angular velocity gyroscope (14) can output the coordinate axis direction of the torso angular velocity and torso angular velocity vector to the torso angular velocity transmitter (15), and the torso angular velocity transmitter (15) can transmit the coordinate axis direction of the torso angular velocity and torso angular velocity vector by means of wired communication or wireless communication.

The processor (2) can detect the status of the torso angular velocity gyroscope (14), and send it to the user through the audio signal or video signal. The torso angular velocity gyroscope (14) has four statuses: angular velocity detector successfully connected, angular velocity detector connection failure, angular velocity detector successfully matched, and angular velocity detector matching failure.

If the torso angular velocity receiver (12) receives the torso angular velocity vector, then the processor (2) will notify the user: angular velocity detector is successfully connected; otherwise, the processor (2) will notify the user: angular velocity detector connection fails.

The head angular velocity gyroscope (11) can output the direction of the head angular velocity coordinate axis to the processor. The torso angular velocity gyroscope (14) can output the direction of the torso angular velocity coordinate axis to the processor (2). The processor (2) can calculate coordinate axis direction difference X of the head angular velocity gyroscope (11) and torso angular velocity gyroscope (14), and judge whether the angular velocity detector matching is successful. If X=0, then the coordinate axis direction of the head angular velocity gyroscope (11) is consistent with that of the torso angular velocity gyroscope (14), and the processor (2) will notify the user: angular velocity detector matching succeeds; if X≠0, then the coordinate axis direction of the head angular velocity gyroscope (11) is inconsistent with that of the torso angular velocity gyroscope (14), and the processor (2) will notify the user: angular velocity detector matching fails.

Assuming c₁=a₁−b₁, c₁=a₁−b₁, c₁=a₁−b₁, the head relative angular velocity vector is [c₁,c₂,c₃].

If the connection or matching of the angular velocity detector fails, the processor (2) sets torso angular velocity vector [b₁,b₂,b₃] as zero vector [0,0,0]. At this moment, head relative angular velocity vector is [a₁,a₂,a₃].

The processor (2) translates the origin of the coordinate system of the head angular velocity gyroscope (11) to the cervical apex of the user, by using the coordinate axis direction of the head angular velocity gyroscope (11) as that of the head coordinate system. Then, the processor (2) will build a three-dimensional head coordinate system for the head of the user. In whatever movement status for the user's head, the origin of the head coordinate system is always in the cervical apex of the user, and the coordinate axis direction of the head coordinate system is always consistent with the coordinate axis direction of the head angular velocity gyroscope (11).

The dead-ahead direction of the digital eyeglasses is consistent with the dead-ahead direction of the user's eyes. Assume that the head status is the initial status when the user stands up, the angle of rotation up and down for the user's head α meets

$$α ∈ [ - \frac{4 π}{5} , \frac{4 π}{5} ] ,$$

and the angle of left and right rotation of the user head β meets

$$β ∈ [ - \frac{4 π }{5} , \frac{4 π}{5} ] .$$

The operation interface is a virtual plane object in the three-dimensional space, it is stored in the form of electronic data in the memory. It is situated in front of the user's glasses. The front here includes dead-ahead front, upper front, lower front, left front and right front. The operation interface is always stable in relation to the head.

The pointer is situated on the two-dimensional operation interface, and its tip coordinate can be expressed with two-dimensional vector. The pointer may have two statuses for switching: “pointer disabled” and “pointer enabled.” When the pointer is in “pointer disabled” status, the pointer can neither move nor click; when the pointer is in “pointer enabled” status, the pointer can move and click.

The user may switch the pointer status by using the head. The method for the head to switch pointer status is: the user makes single squint-blink of the left eye.

After switching to “pointer disabled” status, the pointer is immediately covered by “cross,” to highlight the status change. After switching to the “pointer enabled” status, the pointer immediately returns to its original status, to highlight the status change.

The user can move the pointer with the head. The angular velocity component for the left and right rotation of the head is d₁, and the angular velocity component for the up-and-down rotation of the head is d₂. It is known that head relative angular velocity vector is [c₁,c₂,c₃]. From three-dimensional angular velocity vector [c₁,c₂,c₃], it is possible to extract two-dimensional angular velocity vector [d₁,d₂]. d₁ can generate the horizontal displacement component of the pointer; and d₂ can generate the vertical displacement component of the pointer.

Assume that k₁ϵ(0,+∞), k₂ϵ(0,+∞). The method whereby the head moves the pointer includes the following steps:

S1. If the pointer is in the “pointer disabled” status, then switch S1; otherwise, switch to S2;

S2. The processor (2) calculates the two-dimensional vector [d₁,d₂], switches to S3;

S3. The processor (2) multiplies the components of two-dimensional vector [d₁,d₂] by the scaling factor k₁ and k₂, thus generating the pointer displacement vector [k₁·d₁,k₂·d₂], and switches to S4;

S4. The processor (2) adds the pointer displacement vector [k₁·d₁,k₂·d₂] onto the current pointer coordinates, moves the pointer on the operation interface and switches to S1.

The user may use the head to click the pointer. The method whereby the head clicks the pointer includes the following steps:

S1. If the pointer is in the “pointer disabled” status, then switch to S1; otherwise, switch to S2;

S2. If the user squint-blink, the processor (2) clicks the pointer, switches to S1; otherwise, switches to S1;

Therefore, the user is only required to turn the head and make the squint-blink in order to click any button on the operation interface. Similarly, the user is only required to turn the head and make the squint-blink in order to input the text with the soft keyboard.

The display device may be transparent display device. Transparent display device can display the operation interface in the lower part of the display device, thus avoiding the blocking of the sight line of user by the operation interface, and therefore allowing the user to walk normally. The head-operated digital eyeglasses not only free both hands of the user, but also free both feet of the user.

The digital eyeglasses can include precious decorative materials, such as precious metals and jewels. The decorative materials can decorate the head of the user.

The digital eyeglasses can be installed with the camera, to send the collected real images to the processor. Then the processor can integrate and output the real images and virtual images to the display device. The camera can take photos and record the videos. The camera may be infrared camera, to collect the infrared images.

The digital eyeglasses can be installed with the microphone and loudspeaker, to receive and transmit the audio information. The digital eyeglasses can be installed with the communication chips to realize the remote communication.

The digital eyeglasses can be installed with the eyeball tracking device, to realize the eyeball control function.

The digital eyeglasses can also be equipped with various types of software. For example, the digital eyeglasses can be installed with the voice recognition software, to output the recognized text into the display device.

The power supply may be the built-in power supply, or external power supply.

In summary, the head-operated digital eyeglasses can fully free both hands and both feet of the user. Such eyeglasses allow the user to rapidly and accurately operate the pointer with the head, and can output the image information to broad, three-dimensional space.

The above description and images have disclosed the preferred embodiment of the present invention. This embodiment shall be considered as being used for the explanation of the present invention, instead of being used for restricting the present invention. The scope of protection of the present invention is not limited to this embodiment.

1. One kind of digital eyeglasses, comprising: a left temple, a right temple, a left display device, a right display device, a left infrared transmitter, a right infrared transmitter, a left infrared receiver, a right infrared receiver, a head angular velocity detector, a processor, a memory, and a power supply; wherein: the digital eyeglasses further include a torso angular velocity receiving interface, and wherein the left display device and right display device are configured to display a two-dimensional operation interface and a pointer; the left infrared transmitter emits the infrared to the user's left eye; the left infrared receiver receives the infrared reflected by the user's left eye; the right infrared transmitter emits the infrared to the user's right eye; the right infrared receiver receives the infrared reflected by the user's right eye; the infrared intensity received by the left infrared receiver is converted into the left-eye opening instruction or the left-eye closing instruction; the infrared intensity received by the right infrared receiver is converted into the right-eye opening instruction or the right-eye closing instruction; the left infrared receiver, the right infrared receiver and the processor are configured to identify the user squint-blink instruction; the head angular velocity detector is worn on the head; the head angular velocity detector is configured to output the head angular velocity vector; the torso angular velocity receiving interface can directly receive the torso angular velocity vector through the wired connection with the torso angular velocity emitter; the torso angular velocity receiving interface is configured to also receive the torso angular velocity vector indirectly through the wired connection with the torso angular velocity receiver; the head angular velocity vector and torso angular velocity vector are configured to generate the pointer displacement vector; the processor uses the pointer displacement vector to move the pointer on the operation interface; and the processor uses the squint-blink instruction to click the pointer.

2. One kind of digital eyeglasses, comprising: a left temple, a right temple, a left display device, a right display device, a left infrared transmitter, a right infrared transmitter, a left infrared receiver, a right infrared receiver, a head angular velocity detector, a processor, a memory, a power supply; wherein: the digital eyeglasses further include a torso angular velocity detector, and wherein the left display device and right display device are configured to display a two-dimensional operation interface and a pointer; the left infrared transmitter emits the infrared to the user's left eye; the left infrared receiver receives the infrared reflected by the user's left eye; the right infrared transmitter reflects the infrared to the user's right eye; the right infrared receiver receives the infrared reflected by the user's right eye; the infrared intensity received by the left infrared receiver is converted into the left-eye opening instruction or the left-eye closing instruction; the infrared intensity received by the right infrared receiver is converted into the right-eye opening instruction or the right-eye closing instruction; the left infrared receiver, the right infrared receiver and the processor are configured to identify the user's single-blink instruction; the head angular velocity detector is worn on the head; the head angular velocity detector sends the detected head angular velocity vector to the processor; the torso angular velocity detector sends the detected torso angular velocity vector to the processor; the head angular velocity vector and torso angular velocity vector are configured to generate the pointer displacement vector; the processor uses the pointer displacement vector to move the pointer on the operation interface; the pointer status includes “the pointer disabled” and “pointer enabled”; and the processor uses the single-blink instruction to click the pointer.

3. The digital eyeglasses as in claim 1, further comprising a torso angular velocity detector and perspiration-resistant tape, wherein one side of the perspiration-resistant tape is configured to be fixedly connected with the torso gyroscope, and the other side of the perspiration-resistant tape is configured to be stuck on the torso epidermis, the perspiration-resistant tape is configured to prevent the falloff of torso gyroscope due to the perspiration of the user, and the torso angular velocity detector is configured to send the torso angular velocity to the processor.

4. (canceled)

5. (canceled)

6. (canceled)

7. (canceled)

8. (canceled)

9. (canceled)

10. (canceled)

11. (canceled)

12. (canceled)

13. The digital eyeglasses as in claim 23, wherein the switching method of the pointer status is: the user's squint-blink or single blink.

14. The digital eyeglasses as in claim 23, wherein the switching method of the pointer status is: the user continues to squint the eyes for more than t milliseconds or closes a single eye for more than t milliseconds.

15. The digital eyeglasses as in claim 23, wherein the method that the head moves the pointer includes the following steps:
S1: if the pointer is in the “movement disabled” or “pointer disabled” status, it is transferred to S1; otherwise, it is transferred to S2;
S2: the processor calculates the two-dimensional vector [d₁,d₂], and transfers it to S3;
S3: the processor multiplies the components of two-dimensional vector [d₁,d₂] by zoom factor k₁ and k₂, thus generating the pointer displacement vector [k₁·d₁,k₂·d₂], and transferring it to S4;
S4: the processor adds the pointer displacement vector [k₁·d₁,k₂·d₂] to the current pointer coordinates, thus moving the pointer on the operation interface and transferring it to S1.

16. The digital eyeglasses as in claim 23, wherein the method that the head clicks the pointer includes the following steps,
S1: if the pointer is in “pointer disabled” status, then it switches to S1; otherwise, switch to S2;
S2: in case of the blinking and squinting or single blink of the user, the processor will click the pointer and then switch to S1; otherwise, it will switch to S1.

17. The digital eyeglasses as in claim 1, wherein the pointer status is configured to be switched between “pointer disabled” and “pointer enabled.”

18. The digital eyeglasses as in claim 2, wherein the pointer status is configured to be switched between “pointer disabled” and “pointer enabled.”

19. The digital eyeglasses as in claim 17, wherein, after switching the status, the pointer is configured to immediately send a specific video prompt signal to prompt the change of the status.

20. The digital eyeglasses as in claim 18, wherein, after switching the status, the pointer is configured to immediately send a specific video prompt signal to prompt the change of the status.

21. The digital eyeglasses as in claim 2, further comprising a torso angular velocity detector and perspiration-resistant tape, wherein one side of the perspiration-resistant tape is configured to be fixedly connected with the torso gyroscope, and the other side of the perspiration-resistant tape is configured to be stuck on the torso epidermis, the perspiration-resistant tape is configured to prevent the falloff of torso gyroscope due to the perspiration of the user, the torso angular velocity detector is configured to be configured to send the torso angular velocity to the processor.

22. The digital eyeglasses as described in claim 1, wherein the pointer status is configured to be switched between “movement disabled” and “movement enabled.”

23. The digital eyeglasses as described in claim 2, wherein the pointer status is configured to be switched between “movement disabled” and “movement enabled.”

24. The digital eyeglasses as described in claim 22, wherein, after switching the status, the pointer is configured to immediately send a specific video prompt signal to prompt the change of the status.

25. The digital eyeglasses as described in claim 23, wherein, after switching the status, the pointer is configured to immediately send a specific video prompt signal to prompt the change of the status.

26. The digital eyeglasses as described in claim 22, wherein the switching method of the pointer status is: the user's squint-blink or single blink.

27. The digital eyeglasses as described in claim 22, wherein the switching method of the pointer status is: the user continues to squint the eyes for more than t milliseconds or closes a single eye for more than t milliseconds.

28. The digital eyeglasses as described in claim 22, wherein the method that the head moves the pointer includes the following steps:
S1: If the pointer is in the “movement disabled” or “pointer disabled” status, it is transferred to S1; otherwise, it is transferred to S2;
S2: The processor calculates the two-dimensional vector [d₁,d₂], and transfers it to S3;
S3: The processor multiplies the components of two-dimensional vector [d₁,d₂] by zoom factor k₁ and k₂, thus generating the pointer displacement vector [k₁·d₁,k₂·d₂], and transferring it to S4;
S4: The processor adds the pointer displacement vector [k₁·d₁,k₂·d₂] to the current pointer coordinates, thus moving the pointer on the operation interface and transferring it to S1.

29. The digital eyeglasses as described in claim 22, wherein the method that the head clicks the pointer includes the following steps:
S1: If the pointer is in “pointer disabled” status, then it switches to S1; otherwise, switch to S2;
S2: In case of the blinking and squinting or single blink of the user, the processor will click the pointer and then switch to S1; otherwise, it will switch to S1.
